(19) United States
(12) Patent Application Publication
(10) Pub. No.: US 2010/0114480 A1
(43) Pub. Date: May 6, 2010

(54) NAVIGATION APPARATUS

(75) Inventors: Shinji Sugiyama, Tokyo (JP); Minako Fujishiro, Tokyo (JP); Yoshimi Kobayashi, Hadano-shi (JP); Hirokazu Kadoki, Tokyo (JP); Kazuya Yoneyama, Kawasaki-shi (JP); Yukiko Nakamura, Tokyo (JP)

Correspondence Address: GIFFORD, KRASS, SPRINKLE,ANDERSON & CITKOWSKI, P.C, PO BOX 7021, TROY, MI, 48007-7021, US

(73) Assignee: Toyota Jidosha Kabushiki Kaisha, Toyota-Shi (JP)

(21) Appl. No.: 12/612,120

(22) Filed: Nov. 4, 2009

(30) Foreign Application Priority Data
Nov. 4, 2008 (JP) JP2008-283203

(51) Int. Cl. G01C 21/36

(52) U.S. Cl. 701/207

(57) ABSTRACT

The present invention provides a navigation apparatus that displays map information on a display unit to guide a route to a set destination. The navigation apparatus has a function of displaying information associated with points on the map, which is displayed on a screen, as balloons. The balloons are enlarged and emphasized in different ways during the route guidance to a searched destination and during other operations. In this way, it is possible to preferentially provide useful information to the user.

### BACKGROUND OF THE INVENTION

1. Field of the Invention

The present invention relates to a navigation apparatus that guides user specific route to other locations along roads with map information.

2. Related Background Art

Navigation apparatuses for vehicles and portable terminals which display map information on display devices to guide routes have come into widespread use. JP-2007-133041A discloses a map display control device that is used for the navigation apparatus. The map display control device displays facility information as balloons, and inclines the balloon in the direction of the central point of a scroll target to perform scrolling, when performing a map scrolling display operation. In this way, it is possible to give prominence to the displayed balloons.

In the technique disclosed in JP-2007-133041A, it is possible to improve the visibility of the displayed content using the balloon display. However, when there is a plurality of display targets, it is difficult for the user to discriminate between the displayed balloons. In addition, when there is a plurality of targets, the user is likely to feel that, to the contrary, the display is complicated.

### SUMMARY OF THE INVENTION

It is an object of the present invention is to provide a straight-forward navigation apparatus that intuitively transmits information to the user.

For resolving such object, a navigation apparatus according to the present invention includes: a route guidance unit that guides a route to a destination; a display unit that displays information about areas in the vicinity of a travel route; and an emphasis unit that emphasizes a portion of the area information on the display unit. The area information emphasized by the emphasis unit is changed according to whether the route guidance is performed. The emphasis display includes, for example, display enlargement and display in different colors.

The emphasis unit may emphasize the area information related to the route guidance during the route guidance, and emphasize information requiring attention when traveling during operations other than the route guidance.

The emphasis unit may display the area information as a balloon on the display unit, and the position and size of the balloon may vary depending on the kind and the degree of importance of information to be displayed.

It is possible to emphasize and display area information that is useful for the user by changing the priority of the emphasized and displayed area information according to display content. In this way, information is intuitively provided to the user, and the visibility of the area information is improved for the user. It is easy for the user to discriminate area information by changing the display position or size according to the kind or the degree of importance of the area information.

### BRIEF DESCRIPTION OF THE DRAWINGS

FIG. 1 is a block diagram illustrating the structure of a navigation apparatus according to an embodiment of the invention; and

FIGS. 2 to 8 are diagrams illustrating display examples of the navigation apparatus.

### DESCRIPTION OF THE PREFERRED EMBODIMENTS

Hereinafter, preferred embodiments of the present invention will be described in detail with reference to the attached drawings. To facilitate the comprehension of the explanation, the same reference numerals denote the same parts, where possible, throughout the drawings, and a repeated explanation will be omitted.

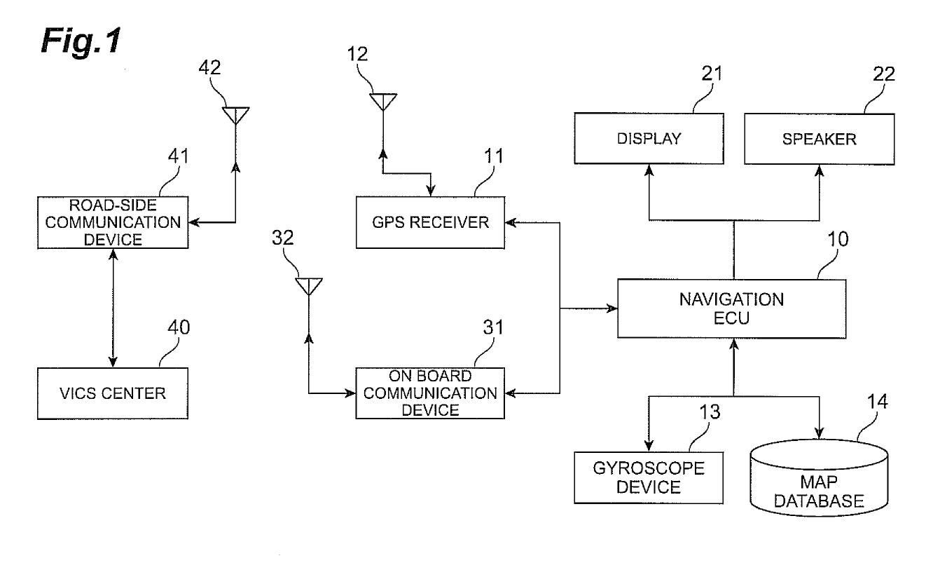

FIG. 1 is a block diagram illustrating the structure of a navigation apparatus according to an embodiment of the present invention. In this embodiment, an in-vehicle navigation apparatus provided in a vehicle will be described as an example.

The navigation apparatus uses a VICS (vehicle information and communication system) and a GPS (global positioning system) maintained as social infrastructure as well as an autonomous navigation apparatus to provide a route or map information. The VICS, which is an infrastructure, includes, for example, a road-side communication device 41 and a communication antenna 42 provided for each area. The road-side communication device 41 is connected to a VICS center 40 by wire or wirelessly.

The navigation apparatus provided in a vehicle has a navigation ECU (electronic control unit) 10, which is a control unit, as a main component. The navigation ECU 10 includes, for example, a CPU, a ROM, and a RAM. The navigation ECU 10 may be formed by combining a plurality of ECUs, and a portion of or the entire navigation ECU 10 may be shared by other systems, for example, a vehicle-installed audio/video device. The navigation ECU 10 also serves as a route setting and search unit.

The navigation ECU 10 is connected to a display 21 and a speaker 22, which are output units. A touch display, which also serves as an input unit, may be used as the display 21. In addition, the navigation ECU 10 is connected to a GPS receiver 11 connected to an antenna 12 that receives signals from a GPS satellite (not shown), and an on board communication device 31 connected to an antenna 32 that receives signals from the road-side communication device 41. In addition, the navigation ECU 10 is connected to a gyroscope device 13, serving as an autonomous navigation device, and a map database (MDB) 14 that stores map information. Various storage media, such as a magnetic disk, an optical disk, and a memory, may be used as the MDB 14. A portion of or the entire MDB 14 may be provided outside the vehicle and may acquire information from an externally provided center by communication with the center.

Next, the operation of this embodiment will be described. Here, an example in which the navigation apparatus performs route guidance will be described. A driver uses the display 21, serving as an input unit, to set a destination. It is preferable to use the MDB 14 to search and display the destination. In this case, it is possible to easily and reliably set the destination. The navigation ECU 10 calculates the current vehicle position on the basis of information output from the gyroscope device 13 and the GPS receiver 11. In addition, the navigation ECU 10 acquires road traffic information, such as traffic congestion information, from the VICS through the on board communication device 31. The navigation ECU 10 determines route candidates from the current position to the destination on the basis of the current position, the destination, and the road traffic information therebetween. Then, the navigation ECU 10 displays the route on the MDB 14 according to the progress of the vehicle, and provides appropriate information about, for example, branch point to the driver. In this case, the information may be displayed on the map as a balloon in which the information and points are associated with each other.

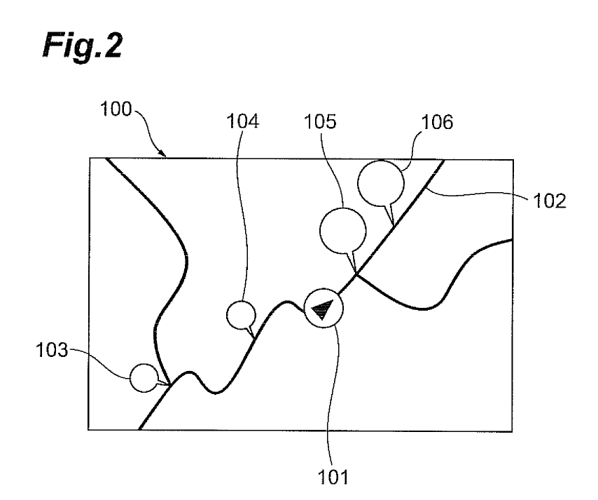

FIGS. 2 to 8 show display examples of the display 21. FIG. 2 shows automatic speed traps posted in the vicinity of a route. Specifically, on a screen 100, an isosceles triangle in a circle indicates a vehicle and a route direction and is represented by a symbol 101. When a route 102 is set, the positions of speed traps in the vicinity of the route are represented by balloons 103 to 106. The balloons 103 to 106 are displayed such that the sizes thereof are changed depending on the density and the number of speed traps. In this way, the positions and density of the speed traps are displayed such that the user can easily visually identify them. During route guidance, only the balloons (the balloons 105 and 106 in FIG. 2) on the route candidates are displayed. However, the route candidates and the other routes may be represented by different colors.

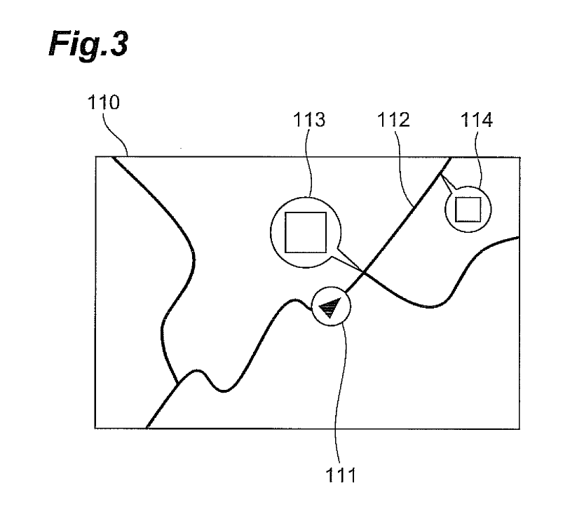

In the display example shown in FIG. 3, on a screen 110, a vehicle 111 is displayed on a set route 112, and warning points (for example, points where traffic accidents occur frequently) are displayed by balloons 113 and 114. In this case, the sizes of the balloons 113 and 114 may vary depending on the frequency of accidents.

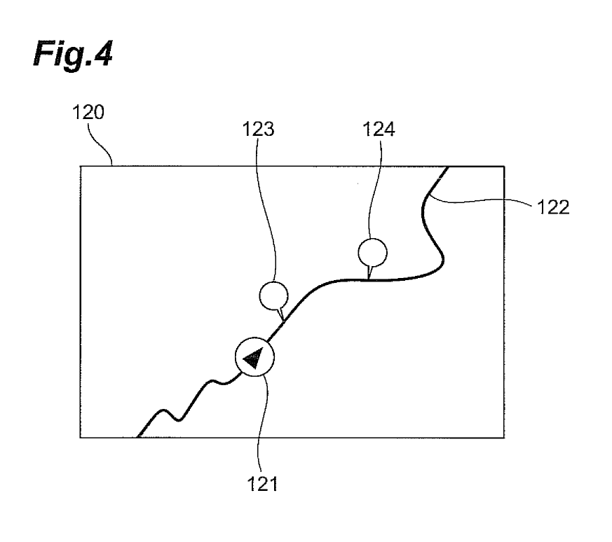

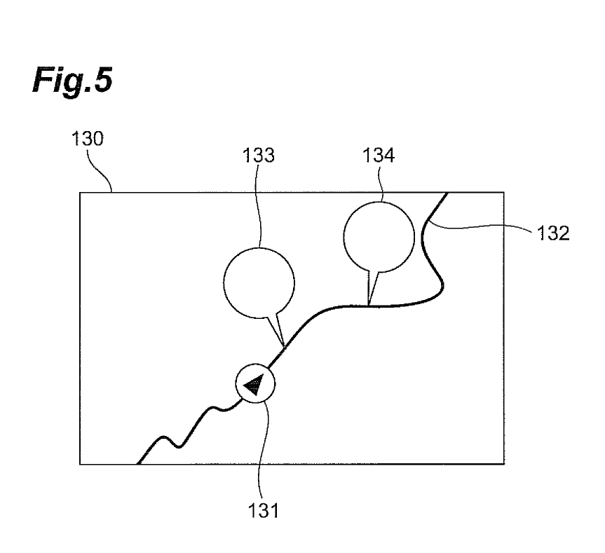

Each of FIGS. 4 and 5 shows an example in which a school zone (a specific area which is adjacent to school grounds and in which traffic regulations are operated in order to ensure the safety of children on their way home or to school) is set on the route. During the time other than the school zone time, for example, as shown in FIG. 4, on a screen 120, the starting point and the end point of the school zone on a route 122 on which a vehicle 121 travels are represented by balloons 123 and 124. In this case, the school zone time may be displayed in the balloons 123 and 124. It is preferable that the driver be alerted even during the time other than the school zone time, since there is a school in the vicinity of the school zone. During the school zone time or the time close to the school zone time, on a screen 130 as shown in FIG. 5, the starting point and the end point of the school zone on a route 132 on which a vehicle 131 travels are represented by balloons 133 and 134 with sizes greater than those shown in FIG. 4.

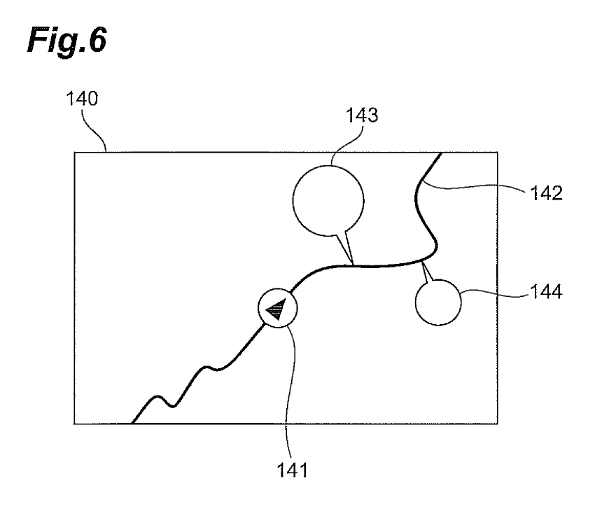

In the display example shown in FIG. 6, on a screen 140, school bus stops on a route 142 on which a vehicle 141 travels are represented by balloons 143 and 144. The balloons may be displayed with a large size during a period of time in which the children get on or off the school bus at the school bus stops.

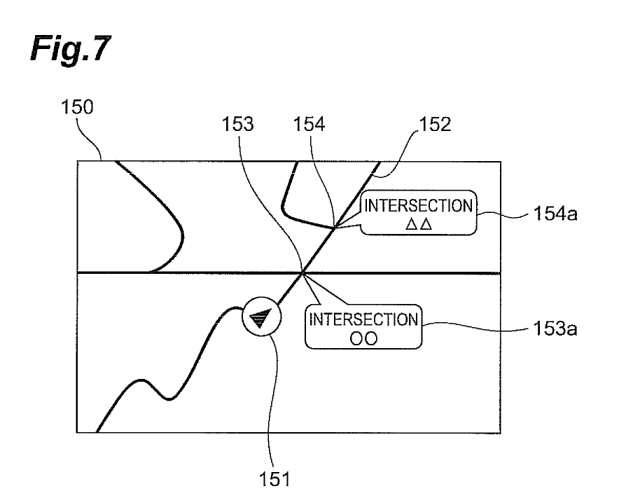

In the display example shown in FIG. 7, on a screen 150, the names of intersections 153 and 154 on a route 152 on which a vehicle 151 travels are displayed in balloons 153a and 154a. In this case, the intersections may be displayed in different ways according to how to pass through the intersections. For example, an intersection where left and right turns are made is displayed with a size that is larger than that of an intersection which the driver is more likely to pass through without making any turn.

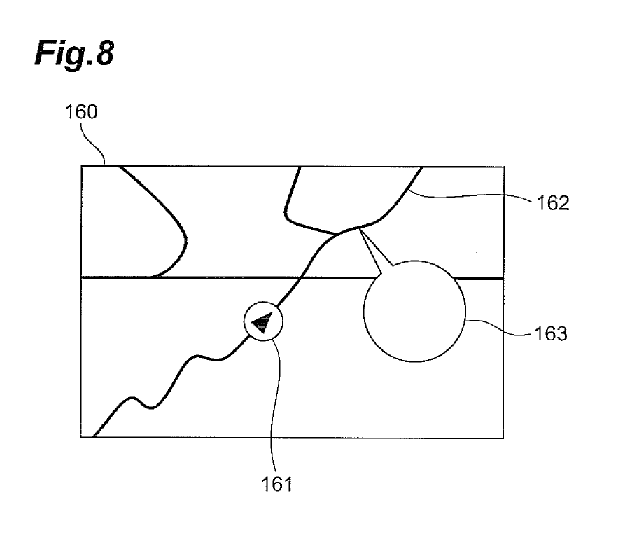

In the display example shown in FIG. 8, on a screen 160, the traffic congestion information of a route 162 on which a vehicle 161 travels is represented by a balloon 163. The balloon 163 may vary depending on the length of traffic congestion and the time required for passing through the traffic congestion. In this case, it is possible to intuitively inform the driver of the state of the traffic congestion.

For example, during route guidance, information about the route guidance shown in FIGS. 7 and 8 may be preferentially displayed, and during the other operations, information about matters that require attention as shown in FIGS. 2 to 6 may be preferentially displayed. In addition, a plurality of information items may be displayed at the same time. In this case, information having the highest priority may be displayed with a size that is larger than that of the other information, or the color or the balloon shape of the information having the highest priority may be emphasized.

In the above-described embodiment, the route guidance to the destination set by the driver through the input unit has been described. The invention may be applied to a structure that learns the traveling pattern of the driver, estimates the destination of the driver on the basis of the learning results even when the driver does not set the destination, and performs route guidance to the estimated destination.

The present invention can be applied to, for example, navigation apparatuses for vehicles and portable terminals, in addition to the in-vehicle navigation apparatus.

What is claimed is:

1. A navigation apparatus comprising:
a route guidance unit that guides a route to a destination;
a display unit that displays information of areas in the vicinity of a travelling path; and
an emphasis unit that emphasizes a portion of the area information on the display unit,
wherein the area information emphasized by the emphasis unit is changed according to whether route guidance is performed.

2. The navigation apparatus according to claim 1,
wherein the emphasis unit emphasizes the area information related to the route guidance during the route guidance, and emphasizes information requiring attention when a vehicle is traveling during operations other than the route guidance.

3. The navigation apparatus according to claim 1,
wherein the emphasis unit displays the area information as a balloon on the display unit, and
the position and size of the displayed balloon vary depending on the kind and the degree of importance of information to be displayed.
